(19) United States
(12) Patent Application Publication
(10) Pub. No.: US 2005/0164007 A1
(43) Pub. Date: Jul. 28, 2005

(54) Method for the production of low orientation thermoplastic film, the film produced thus and use thereof

(75) Inventors: Uwe Numrich, Gross-Zimmern (DE); Hans Lorenz, Darmstadt (DE); Herbert Groothues, Weiterstadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHMGMBH & CO. KG, DARMSTADT (DE)

(21) Appl. No.: 10/514,712

(22) PCT Filed: Jun. 13, 2003
(86) PCT No.: PCT/EP03/06237

(30) Foreign Application Priority Data
Aug. 6, 2002 (DE) 102 36 045.6

(51) Int. Cl. B32B 9/04

(52) U.S. Cl. 428/411.1; 264/210.1

(57) ABSTRACT

The invention relates to a method for the production of films in the thickness range of 20 ?m 1,000 ?m from thermoplastic plastics by extrusion of the plastic through a broad slot nozzle (4) and polishing of the melt film (5), escaping from the broad slot nozzle in a polishing unit, comprising at least three or four rollers (1, 2, 3), whereby a first roller pair (1, 2) forms a polishing gap for holding the melt film and the melt film is then run behind said polishing unit gap through a subsequent polishing gap or a subsequent pressing gap. The above is characterised in that the ratio of the width of the nozzle gap and the film thickness lies on the range 1:1 to 6:1 and the quotient of the film web speed in the subsequent polishing gap or the subsequent pressing gap divided by the film web speed in the polishing gap formed by the roller pair (1, 2) lies in the range 0.8 to 1.05.

### FIELD OF THE INVENTION

The invention relates to low-orientation thermoplastic films.

### PRIOR ART

DE 38 42 796 (Röhm GmbH) describes polymethyl methacrylate (PMMA) films based on PMMA moulding compositions with low elastomer particle size and high elastomer content. That application describes a chill roll process in which the melt film emerging from the extrusion die is taken off and cooled by way of a single roller.

WO 96/30435 and EP 763 560 (Mitsubishi Rayon) describe the production of PMMA films of thickness up to 0.3 mm, based on particular PMMA formulation: an modifier based on polybutyl acrylate with a particular particle diameter, and also PMMA matrix polymer III and the (optional) addition of a melt strength modifier (polymer I).

The film is produced using a single-roller process (known as a chill-roll-melt-casting process) in which the thermoplastic melt is brought into contact with a single metal roller during the cooling and solidification process and is cooled. It is expressly pointed out that the thermoplastic melt for producing films of the claimsed thickness range cannot be moulded between two metal rollers. When compared with the double-roller process, this process has marked disadvantages which have a decisive effect on film quality. Impact-modified PMMA moulding compositions have a fundamental tendency to form gel specs, and, unlike in the double-roller (smoothing) process, these are not pressed below the film surface during the shaping process on the single chill-roll roller, and they therefore remain visible as an optical defect. This is particularly disadvantageous in the subsequent printing process to produce decorative films, in which clearly visible defects become apparent in the region of the gel specs. In addition, the film surface which faces away from the chill-roll roller and which cools freely in the atmosphere exhibits noticeable surface haze, resulting from the differences in the extent of volume contraction of the elastomer particles and of the PMMA matrix. The result of this is a distinct “hill and valley” surface structure which scatters light and thus brings about a disadvantageous haze effect.

DE 195 44 563 (Röhm GmbH) describes the impact-modified PMMA moulding compositions used to produce the films of the invention. (not deleted).

DE 40 18 530 (RöGmbH) describes a process for producing solid sheets or films of thickness less than 1 mm from a thermoplastic with glass transition temperature >50° C. The smoothing is achieved by conducting the film on a continuous belt. The sheets or films obtained are practically free from orientation and birefringence.

EP 659 829 (Röhm GmbH) describes a weathering-protection film and mouldings coated therewith, the film having the function not only of protection from weathering but also that of absorbing UV radiation. It is composed of a hard phase made from PMMA and a toughening phase, the UV absorber being present in the hard phase.

EP 391 193 (Bayer AG) describes a process for producing optically isotropic extrusion films, both sides of which are glossy, with a thickness below 0.6 mm, which are either
1. produced by extrusion followed by calendering between a lacquered elastic roller and a high-gloss steel roller or
2. moulded in two extrusion steps, wherein, in the first step, a film which has high gloss on one side and is matt on the other side are [sic] produced by extrusion followed by calendering between a ground elastic roller and a high-gloss steel roller. In a second extrusion stage, the film produced in the first step is coated with the melt of the same thermoplastic on the matt side of the film, and this resultant coated film is again calendered between a high-gloss steel roller and a ground elastic roller, the high-gloss side of the coated film facing towards the roller made from ground elastic material. A disadvantage of process 1 is that ir cannot be implemented industrially, since the lacquer layers on the rubber rollers very rapidly embrittle when exposed to the high temperature of the melt. To reduce the effect of the high melt temperatures, the lacquered rubber rollers may be cooled in a water bath, but the moisture adversely affects the surface quality of the film.

Process 2 is extremely uneconomic, because two extrusion steps are required to produce the film. In addition, the extrusion coating of a film with melt and the subsequent calendering, in particular in the thickness range claimsed according to the invention, leads to disadvantageous properties.

EP 165 075 (Exxon) describes a process for producing a film, glossy on both sides, from 10-85% by weight of an elastomer and 90-15% by weight of a polyolefin, by passing the extruded web at a temperature above its softening point through the nip of counter-rotating rollers. One of the rollers is a high-gloss steel cooling roller and the other roller is a roller with a high-gloss rubber surface, the result being that the film is cooled. The films thus obtained have a thickness of from 25 to 250 micron (10⁻⁶).

EP 294 706 (Röhm GmbH) describes a process for producing films, smoothed on both sides, the smoothing component used in the process being a previously smoothed film which is produced in advance in the processes and is returned.

EP 916 474 (General Electric Company) describes the production of a polycarbonate (PC) film coated on one side with a UV-curable coating. One side of the PC film has a texture. The film has low birefringence and high transmittance, because the refractive indices of film and coating are matched to one another.

EP 916 475 (General Electric Company) describes the production of films from thermoplastic materials with polished surfaces and with a birefringence less than 25 μm. This is achieved by way of a smoothing stack made from a metal roller and a polytetrafluoroethylene-coated roller. The polytetrafluoroethylene coating is applied to a rubber covering.

WO 96/40 480 (Avery Derrison [sic] Corp.) describes an extrusion coating process. In this, an optically clear material is extruded onto an auxiliary film (12) in the roller nip. The composite is then further coated with a polymerized, further material. The extrusion coating process followed by pigmentation saves the painting step which is associated with solvent emissions.

A second coloured layer may either be coextruded onto the composite or cast from a solution.

FIG. 11.5 on page 373 of the book “Plastics Extrusion Technology” (2nd Edition, Hanser, (1967)) by Friedhelm Henson (Ed.) describes the extrusion coating process also described in WO 96/40 480.

DE 198 130 01 processes an impact-modified PMMA moulding composition according to DE 195 44 563 to give a high-gloss film which is practically free from gel specs, has a hard surface, and can be used in the “in-mould film-decoration” process. The melt is extruded, fed by way of a die with adjustable lips to the smoothing stack of the invention, which has been designed to generate particularly high compressive forces in the roller nip. The polishing rollers have been ground convex. The films are used for the surface-decoration of high-quality thermoplastic mouldings. The high compressive forces in the roller nip give films with extremely high orientation.

Object and Solution

An object was to develop a simple and low-cost extrusion process for films, permitting films to be produced from thermoplastic materials in the thickness range from 20 μm to 1 000 μm with application-oriented surface effects, e.g. gloss, pigmented, pigmented [sic], matted, UV-absorbent or light-scattering, where the sides of the film may have different texturing. The films are intended to withstand high mechanical stresses.

The object is achieved by way of a

Process for producing films in the thickness range from 20 μm to 1 000 μm from thermoplastics through extrusion of the plastic through a slot die and smoothing the melt film emerging from the slot die in a polishing stack, composed of at least three or four rollers, where a first roller pair (1, 2) forms a polishing nip to receive the melt film and, downstream of this polishing stack nip, the melt film is passed through a subsequent polishing nip or through a subsequent pressure nip,

characterized in that

the ratio between the width of the die gap and the film thickness is in the range from 1:1 to 6:1, and in that the quotient obtained by dividing the film web speed in the subsequent polishing nip or in the subsequent pressure nip by the film web speed in the polishing nip formed by the roller pair (1, 2) is in the range from 0.8 to 1.05.

Balancing of the width of the die gap, of the film thickness and of the quotient calculated by dividing the film web speed in the subsequent polishing nip or in the subsequent pressure nip by the film web speed in the polishing nip [lacuna] by the roller pair (1, 2) achieves low molecular orientation of the resultant films, which contributes decisively to their high mechanical strength, in particular including mechanical strength perpendicular to the direction of extrusion.

### FIGURES

The invention is illustrated by the following figures, but there is no intention that it be restricted to these embodiments.

Key

FIG. 1: Arrangement according to the invention with four rollers, viewed perpendicularly to the direction of extrusion.
1=second polishing stack roller, e.g. with elastic surface made from silicone
2=first polishing stack roller, e.g. with surface made from polished steel
3=third polishing stack roller e.g. functioning exclusively as cooling roller
31=fourth roller, e.g. with elastic-coated surface, functioning as pressure roller.
4=film extrusion die
5=melt film (e.g. made from impact-modified polymethyl methacrylate).

FIG. 2: Arrangement according to the invention with four rollers for producing a laminate with a polyethylene terephthalate film. Key as FIG. 1.
6=polyethylene terephthalate film
7=film laminate (polyethylene terephthalate with, for example, impact-modified polymethyl methacrylate)

FIG. 3: Arrangement according to the invention with three rollers, where the roller (3) forms a subsequent polishing nip with the roller (2). Key as FIG. 1.

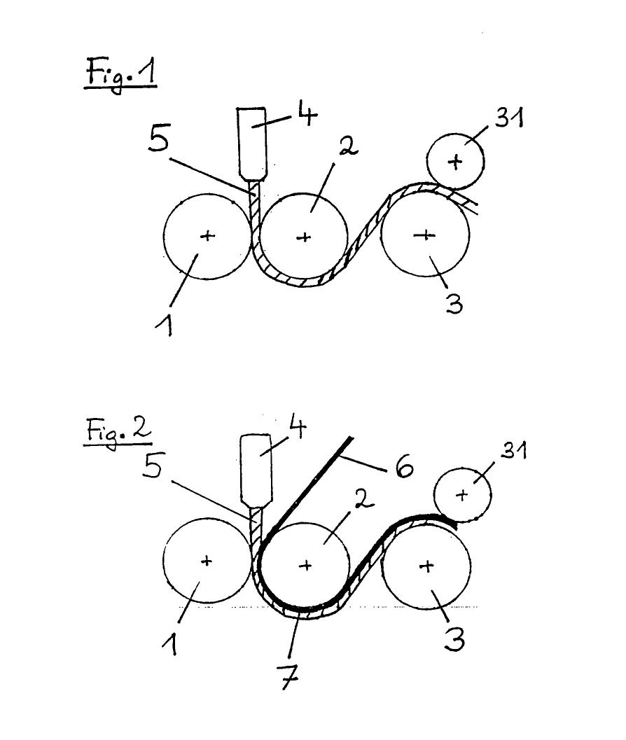

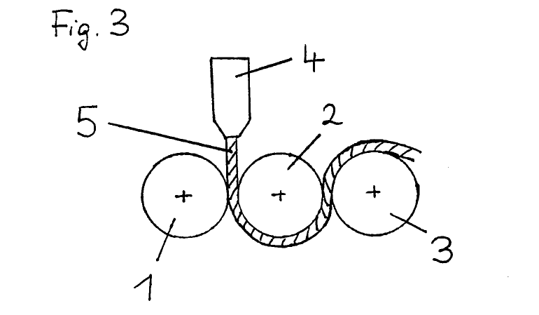

### WORKING OF THE INVENTION

The invention relates to a process for producing films in the thickness range from 20 μm to 1 000 μm, preferably from 20 μm to 750 μm, particularly preferably from 20 μm to 500 μm, from thermoplastics through extrusion of the plastic through a slot die and smoothing the melt film emerging from the slot die in a polishing stack, composed of at least three or four rollers, where a first roller pair (1, 2) forms a polishing nip to receive the melt film and, downstream of this polishing stack nip, the melt film is passed through a subsequent polishing nip or through a subsequent pressure nip,

characterized in that

the ratio between the width of the die gap and the film thickness is in the range from 1:1 to 6:1, preferably in the range from 1:1 to 4:1, particularly preferably in the range from 1:1 to 3:1, in particular in the range from 1:1 to 2:1, and in that the quotient obtained by dividing the film web speed in the subsequent polishing nip or in the subsequent pressure nip by the film web speed in the polishing nip formed by the roller pair (1, 2) is in the range from 0.8 to 1.05, preferably in the range from 0.85 to 1, particularly preferably in the range from 0.9 to 1.

The melt produced by means of a single- or twin-screw extruder (melt pumps may optionally be used to provide a constant stream of melt) is fed by way of a die designed for film extrusion to the shaping process of the invention.

Melt filtration preferably takes places between the melt pump and the extrusion die. The film width resulting from the width of the die may be 1 500 mm, for example. The width of the die gap or the opening between the die lips may be 0.6 mm, for example. The temperatures of the melt are selected in accordance with the usual processing temperatures for the materials used. The melt is dimensioned in the defined roller nip and smoothed and cooled by way of the surface of the temperature-controlled rollers.

The entire polishing stack is composed of at least three or four rollers. The two first rollers here form a polishing stack nip to receive the melt film which emerges from the slot die. The arrangement of the slot die is preferably directly above the polishing stack nip. A usual distance between the slot die and the polishing stack nip may be from 2 to 20 cm, for example.

Possible Roller Arrangements and Surface Finishes

Both rollers of the roller pair (1, 2) may have a surface made from steel.

One roller of the roller pair (1, 2) may have a made from steel, while the other roller may have a surface whose hardness is lower than that of steel. The roller with a surface made from steel [lacuna] a structured or matted steel surface or a high-gloss-polished steel surface with a roughness depth of RA 0.002-0.006 or, respectively, RT=0.02-0.04, measured to DIN 4768. One of the rollers preferably has an elastic heat-resistant surface, for example made from silicone rubber or fluorine rubber. The surface of this roller may be smooth or may have been matted.

The roller with a surface whose hardness is lower than that of steel may have a surface made from an elastic, heat-resistant material whose Shore-A hardness is in the range from 30 to 90.

A third roller (3) may be so closely adjacent to one of the rollers of the roller pair (1, 2) as to form, between these rollers, a polishing nip through which the melt film is passed under pressure.

A third roller (3) may be so far distant from the nearest roller of the roller pair (1, 2) that no further roller nip is formed between these rollers, the third roller, forming, with a pressure roller (31), a pressure nip through which the melt film is passed.

The ratio between the widths [sic] of the die gap and the thickness of the film is in the stated range in order to minimize molecular orientation of the melt film in the machine direction (MD) due to the linear pressures arising in the polishing stack. If the width of the die gap is assumed to be 0.6=m, the thickness of the film is then in the range from 0.6 to 0.1 mm. The linear pressures resulting in the polishing stack nip in the process of the invention are in the range from 50 N/cm to 1.

If use is made of a roller with a surface made from an elastic, heat-resistant material whose Shore-A hardness is in the range from 30 to 90, the linear pressures are generally not higher than 300 N/cm.

The width of the die gap is understood to be the distance between the die lips of the slot extrusion die.

At least one further third roller (3) follows the first roller pair. The melt film emerging here from the polishing stack nip is laid on or around this roller for cooling and/or shaping.

The third roller may be so closely adjacent to one of the rollers of the roller pair (1, 2), e.g. to the second roller (2), as to form, between these rollers, a further polishing nip, through which the melt film is passed. As in the first polishing nip, these rollers exert a pressure on the melt film.

The third roller (3) may be so far distant from the nearest roller of the roller pair (1, 2) that no further roller nip is formed between these rollers. In this case, the third roller forms, with a pressure roller (31), a pressure nip through which the melt film is passed. The pressure roller is generally not a driven roller. It preferably has an elastic coating and serves for lay-flat of the film web.

Besides the third roller, or third and fourth roller, further rollers may, where appropriate, be present and take or pass the (melt) film from the third roller. Particularly in the case of relatively thick films in the range from 400 micrometer (μm) to 1 000 micrometer thickness, it can be advisable to use two or more cooling rollers in succession.

The quotient obtained by dividing the film web speed in the subsequent polishing nip or in the subsequent pressure nip by the film web speed in the polishing nip formed by the roller pair (1, 2) is particularly to be small, in order to avoid stretching of the melt film in the machine direction (MD) and, associated therewith, molecular orientation of the film.

A matted roller surface is a surface treated so as to induce, on the film, a controlled, periodic divergence from the high-gloss surface. These rollers are also termed embossing rollers. In the case of a steel roller, one way of providing a fine matt surface is by way of electrical engraving, laser engraving, or sandblasting, on a surface which was previously smooth.

The temperatures of the melt are selected in accordance with the usual processing temperatures for the materials used.

Examples of types of film which can be produced using the process of the invention are the following:
films with a smooth surface on both sides,
films with one smooth surface and one matted or structured surface
films with a matted or structured surface on both sides

Films may generally also be coextruded or laminated films.

Suitable Thermoplastics

The following materials may be used as thermoplastic materials for the films.

Polymethyl methacrylate (PMAA), impact-modified PMMA (im PMMA), blends made from PMMA or made from im PMMA and fluoropolymer, e.g. polyvinylidene fluoride (PVDF), where the mixing ratio between PMMA or im PMMA and PVDF may be from 10:90 to 90:10 parts by weight, for example. For the purposes of the present invention, fluoropolymers are polymers which can be obtained through the free-radical polymerization of olefinically unsaturated monomers having at least one fluorine substituent at their double bond. Copolymers are also included here. These copolymers may contain, besides one or more fluorine-containing monomers, other monomers which are copolymerizable with these fluorine-containing monomers.

The fluorine-containing monomers include chlorotrifluoroethylene, fluorovinylsulphonic acid, hexafluoroisobutylene, hexafluoropropylene, perfluorinated vinyl methyl ether, tetrafluoroethylene, vinyl fluoride and vinylidene fluoride. Among these, particular preference is given to vinylidene fluoride.

Examples of other suitable thermoplastics are acrylonitrile-butadiene-styrene copolymers (ABS), acrylonitrile-styrene-acrylate copolymers (ASA), methyl methacrylate-modified ABS (MABS), impact-modified polystyrene (im PS), PETG (amorphous polyethylene terephthalate), and polycarbonate (PC).

Laminate Films

In one particular embodiment, a laminate is produced with a polyethylene terephthalate film (e.g. Mylar® film, Dupont-Teijin) or with a polypropylene film. A first roller made from high-gloss-polished steel and a second roller with an elastic surface, e.g. made from silicone rubber, form the polishing nip. A melt film made from, for example, polymethyl methacrylate, or from an impact-modified polymethyl methacrylate or from a polymethyl methacrylate/polyvinylidene fluoride blend is extruded into this nip, while at the same time a polyethylene terephthalate film whose thickness is, for example, 50 μm is passed through on the side of the second roller with an elastic surface, [sic]. The resultant laminate, the total thickness of which may, for example, be 100 μm, is passed over a third roller which is adjacent to the second roller and functions as a cooling roller, and is thus cooled. In this case, the third roller forms, with a pressure roller (31), a pressure nip through which the cooled melt film is passed.

The laminate may in turn be separated subsequently. The resultant film then has a high-gloss surface on the side where the PET film or polypropylene film was present.

Test Methods

The advantages of the films of the invention may, inter alia, be characterized by way of the following measured variables, some of which, for example, can also be measured parallel to and perpendicularly to the direction of extrusion.

Modulus of elasticity, tensile strength and tensile strain at break were tested to ISO 527-3, the clamped length being 60 mm and the test velocity being 50 mm/min.

Pencil hardness may be determined to ASTM D 3363-92.

Gloss level may be measured at 60° C. to DIN 67530.

Haze may be measured to ASTM D 1003. For the calculation of surface haze, the haze of the film after silicone-oil treatment on both sides was subtracted from the haze measured in the untreated state.

Shrinkage measurement: “total recovery” determined. For this, a test specimen of dimensions 100×100 mm is heat-conditioned at 160° C. for 30 min. Recovery (thermal relaxation) is defined as the change in dimensions of the test specimen (always measured at room temperature) caused by its shrinkage on heating to a particular temperature. It is determined as the percentage recovery of the separation between two marks on the test specimen, based on their separation prior to shrinkage.

Advantageous Effects

The films of the invention have comparatively little orientation of the polymer molecules, resulting in advantageous mechanical properties.

The films have low shrinkage, low thickness tolerance and isotropic mechanical properties. Surface quality (low level of fish-eyes/number of gel specs) is high.

Possible Applications

The films open up a wide scope of possibilities for application-orientated surface effects, such as: glossy, pigmented, matted (embossed), matted (particle-modified), UV-absorbent, light-scattering.

This makes the films suitable for a wide variety of applications, examples of their use being in processes for the production of decorative films, UV-protection films, dry-painting films, scratch-protection films for optical data carriers, and data carrier materials which are printed by continuous printing processes, such as gravure printing, flexographic printing, offset printing, digital printing, rotary screen printing, or transfer printing processes, and/or are processed in continuous laminating processes, such as colamination of films, lamination of thermoplastic sheet materials and thermoplastic profile materials, wrapping techniques, coil coating processes and/or continuous coating processes, such as coating to prevent water droplet formation, or to provide antibacterial properties, or to provide self-cleaning properties, or to resist graffiti, or to resist scratching, or to provide electrical conductivity, optionally combined with embossing processes.

The particular embodiment described above of a laminate film made from polyethylene terephthalate film or polypropylene film with polymethyl methacrylate, with impact-modified polymethyl methacrylate or with polymethyl methacrylate/polyvinylidene fluoride blend has high mechanical strength and high heat resistance. The laminated film is therefore suitable for further processing with exposure to high mechanical and/or thermal stress, for example that which can arise in printing or coating processes. When comparison is made with the films of the prior art, there is a marked reduction in the risk of web break or of adhesion to guide rollers.

General Example of Film Production

An example of the production of a film from impact-modified polymethyl methacrylate may proceed as follows.

In one example, an impact-modified polymethyl methacrylate moulding composition of the following structure is used. DE 38 42 796 C2, for example, discloses the preparation of this type of impact-modified moulding composition. The material is a two-shell polymer which has an inner toughening phase made from 99% by weight of butyl acrylate and 1% by weight of allyl methacrylate, and has an outer hard phase made from 96% of methyl methacrylate and 4% by weight of butyl acrylate. The impact modifier is used as moulding composition in equal parts by weight with a polymethyl methacrylate matrix moulding composition made from 96% of methyl methacrylate and 4% by weight of methyl acrylate, and extruded to give a film.

Film Extrusion Plant

The moulding composition used is melted in a single-screw extruder and fed to a flat-film die, which distributes the melt across its width. The width of the flat-film die may be 1 500 mm, for example. The gap width of the flat-film die may be 0.4 mm, for example. The temperature of the emerging melt is about 250° C. The arrangement of the flat-film die is vertically above a polishing stack roller pair. One of the roller (2) has a high-gloss-polished steel surface, while the other roller (1) has a matted surface made from silicone rubber. The diameter of the rollers is 400 mm. The two rollers have been temperature-controlled to a temperature of 80° C. The thickness of the film is 0.15 mm. The linear pressures arising in the polishing stack nip are indicated on instrumentation on the extrusion plant and are in the region of about 100 N/cm. On the side of the roller with the high-gloss-polished surface made from steel, the film web is guided over a third roller whose diameter is 250 mm and which is about 300 mm distant. The third roller has been temperature-controlled to a temperature of 60° C. The third roller forms a pressure nip with a fourth roller. The diameter of the fourth roller is 140 mm.

The quotient calculated by dividing the film web speed in the pressure nip by the film web speed in the polishing nip formed by the roller pair (1, 2) is 0.98.

The film web is then passed over two or more support rollers and, when completely cooled, wound onto a roll.

The resultant film web, matted on one side, is of highs quality with respect to isotropy of mechanical properties, to thickness tolerance, to shrinkage and to number of gel specs.

1. A process for producing a film in the thickness range from 20 μm to 1000 μm, from thermoplastics, comprising extruding the plastic through a slot die, and smoothing the melt film emerging from the slot die in a polishing stack, composed of at least three or four rollers, wherein a first roller pair (1, 2) forms a polishing nip to receive the melt film, and, downstream of this polishing stack nip, the melt film is passed through a subsequent polishing nip or through a subsequent pressure nip,
and wherein, characterized in that
the ratio between the width of the die gap and the film thickness is in the range from 1:1 to 6:1, and the quotient, obtained by dividing the film web speed in the subsequent polishing nip, or in the subsequent pressure nip, by the film web speed in the polishing nip, formed by the roller pair (1, 2), is in the range from 0.8 to 1.05.

2. The process according to claim 1, wherein both rollers of the roller pair (1, 2) have a surface made from steel.

3. The process according to claim 1, wherein one roller of the roller pair (1, 2) has a surface made from steel, while the other roller has a surface whose hardness is lower than that of steel.

4. The process according to claim 2, wherein the roller with a surface made from steel, has a structured or matted steel surface or has a high-gloss-polished steel surface with a roughness depth of RA 0.002-0.006, or, respectively, RT=0.02-0.04, measured to DIN 4768.

5. The process according to claim 3, wherein the roller with a surface, whose hardness is lower than that of steel, has a surface made from an elastic, heat-resistant material, whose Shore-A hardness is in the range from 30 to 90.

6. The process according to claim 1, wherein a third roller (3) is so closely adjacent to one of the rollers of the roller pair (1, 2), as to form, between these rollers, a polishing nip through which the melt film is passed under pressure.

7. The process according to claim 1, wherein a third roller (3) is so far distant from the nearest roller of the roller pair (1, 2), that no further roller nip is formed between these rollers, the third roller, forming, with a pressure roller (31), a pressure nip through which the cooled melt film is passed.

8. The process according to claim 1, wherein a polyethylene terephthalate film or a polypropylene film is passed into the roller nip on the side of the roller with a surface whose hardness is lower than that of steel, producing a laminate with the extruded film material.

9. The process according to claim 8, wherein a laminate film is produced from polyethylene terephthalate film and polymethyl methacrylate or impact-modified polymethyl methacrylate.

10. The process according to claim 8, wherein a laminate film is produced from polyethylene terephthalate film and a polymethyl methacrylate/polyvinylidene fluoride blend.

11. A film capable of production in a process according to claim 1.

12. A decorative film, a UV-protection film, a dry-painting film, a scratch-protection film for optical data carriers, or a data carrier material, comprising the film of claim 11, and
wherein said film is subjected to one or more processes selected from a continuous printing process, gravure printing, flexographic printing, offset printing, digital printing, rotary screen printing, a transfer printing process, a continuous laminating process, colamination of films, lamination of thermoplastic sheet materials and thermoplastic profile materials, wrapping techniques, a coil coating process, a continuous coating process, coating to prevent water droplet formation, coating to provide antibacterial properties, coating to provide self-cleaning properties, coating to resist graffiti, coating to resist scratching, coating to provide electrical conductivity, or an embossing process.

13. A process for coating a film, comprising applying a coating to the film of claim 11.

14. A process for coating a substrate, comprising applying the film of claim 11 to a substrate.

15. A process for laminating a film, comprising applying a laminate to the film of claim 11.

16. A process for laminating a substrate, comprising applying the film of claim 11 to the substrate.

17. The process according to claim 3, wherein the roller with a surface made from steel, has a structured or matted steel surface or has a high-gloss-polished steel surface with a roughness depth of RA 0.002-0.006, or, respectively, RT=0.02-0.04, measured to DIN 4768.

18. The process according to claim 2, wherein a third roller (3) is so closely adjacent to one of the rollers of the roller pair (1, 2), as to form, between these rollers, a polishing nip through which the melt film is passed under pressure.

19. The process according to claim 3, wherein a third roller (3) is so closely adjacent to one of the rollers of the roller pair (1, 2), as to form, between these rollers, a polishing nip through which the melt film is passed under pressure.

20. The process according to claim 2, wherein a third roller (3) is so far distant from the nearest roller of the roller pair (1, 2), that no further roller nip is formed between these rollers, the third roller, forming, with a pressure roller (31), a pressure nip through which the cooled melt film is passed.
